(19) United States
(12) Patent Application Publication
(10) Pub. No.: US 2013/0284099 A1
(43) Pub. Date: Oct. 31, 2013

(54) Enhanced Animal Mattress with Burrowing Feature

(71) Applicant: Franklin Wilson Oakes, JR., Houghton Lake, MI (US)

(72) Inventor: Franklin Wilson Oakes, JR., Houghton Lake, MI (US)

(21) Appl. No.: 13/685,164

(22) Filed: Nov. 26, 2012

Related U.S. Application Data
(60) Provisional application No. 61/638,055, filed on Apr. 25, 2012.

(51) Int. Cl. A01K 29/00

(52) U.S. Cl. CPC A01K 29/00
USPC 119/28.5

(57) ABSTRACT

An enhanced animal mattress with burrowing feature includes a cradling member, a cushion cover, and a cushion base. The cushion base is positioned within the cushion cover where the cushion cover includes a top layer, a bottom layer, and a side panel. The cradling member is positioned above the cushion cover and the cushion base and can be connected to either the top layer or cushion cover and the cushion base. Depending on the connection between the cradling member and the cushion cover, the cushion base may or may not be removed from the cushion cover. The cradling member can include many different shapes and patterns as the enhanced animal mattress with burrowing feature differentiates between different embodiments.

The current application claims a priority to the U.S. Provisional Patent application Ser. No. 61/638,055 filed on Apr. 25, 2012.

### FIELD OF THE INVENTION

The present invention relates generally to an animal mattress. More particularly, the present invention relates to an animal mattress with excess material attached as multiple cloth swatches that form a pattern on the center top portion of the bed, and can be matted down, by the animal, to form a shape for maximum comfort.

### BACKGROUND OF THE INVENTION

Bed scratching in pets is seen in virtually all domesticated mammalian species. The compulsion stems from an instinctual need to flatten the ground below them to create a comfortable sleeping area, to leave a territorial mark, and in some cases, be used as form of protection or cover.

In the wild larger animals will typically scratch up large piles of natural materials such as leaves, pine needles or dirt to form a comfortable sleeping mound. The scratch marks are used as strong territorial signs that establish clear boundaries for other animals. Unlike larger animals, smaller animals have a greater tendency to burrow into their bedding instead of just scratching it up. This instinctual behavior is done to form a protection against the elements and provide cover from predators. Although, animal mattresses come in a plurality of configurations, the use of specific designs or materials that satisfy a pets instinctual need to scratch and burrow have been limited in their implementation.

It is thus an object of the present invention to provide an animal mattress that uses excess material and manageable fabrics incorporated in a plurality of patterns that allow maximum comfort while satisfying a pet's instinctual need to scratch, paw, and burrow the bedding material in order to feel safe.

### BRIEF DESCRIPTION OF THE DRAWINGS

FIG. 1 is a perspective view of the present invention in a first embodiment where a cradling member being utilized by a household pet.

FIG. 2 is a perspective view of the present invention in the first embodiment that utilizes the plurality of radial members.

FIG. 3 is a top view of the present invention in the first embodiment that utilizes the plurality of radial members.

FIG. 4 is a bottom view of the first embodiment where the cradling member is not connected.

FIG. 5 is cross sectional view of the FIG. 4 illustrating a cushion base within a cushion cover.

FIG. 6 is bottom view of the first embodiment illustrating stitches, where the stitches connect the plurality of radial members to the cushion base and cushion cover.

FIG. 7 is bottom view of the first embodiment illustrating an opening and closing device, where the plurality of radial members is only connected to a top layer of the cushion cover.

FIG. 8 is a top view of the present invention in a second embodiment that utilizes a plurality of concentric members arranged in a circular pattern.

FIG. 9 is bottom view of the second embodiment illustrating the stitches, where the stitches connect the plurality of concentric members to the cushion base and cushion cover.

FIG. 10 is bottom view of the second embodiment illustrating an opening and closing device, where the plurality of concentric members is only connected to the top layer of the cushion cover.

FIG. 11 is a perspective view of the present invention in the third embodiment that utilizes a lateral wall member.

FIG. 12 is a side view of the third embodiment illustrating an entrance opening.

FIG. 13 is a side view of the third embodiment.

FIG. 14 is a cross section view of FIG. 13 illustrating filling materials.

FIG. 15 is bottom view of the third embodiment illustrating the stitches, where the stitches connect the lateral wall member to the cushion base and cushion cover.

FIG. 16 is bottom view of the third embodiment illustrating an opening and closing device, where the lateral wall member is only connected to the top layer of the cushion cover.

### DETAIL DESCRIPTIONS OF THE INVENTION

All illustrations of the drawings are for the purpose of describing selected versions of the present invention and are not intended to limit the scope of the present invention.

The present invention is an animal mattress that can come in a plurality of configurations. The shape of the present invention can be configured into any generally acceptable geometric shapes or sizes. Three embodiments of the present invention are hereinafter describes, where one does not precede the other. The present invention comprises a cradling member 1, a cushion cover 7, and a cushion base 8. The cradling member 1 of the present invention differentiates in between the three embodiments while the cushion cover 7 and the cushion base 8 remain consistence for all three embodiments. The cradling member 1 of all three embodiments provides comfort surface while resting animals can scratch, paw, and burrow, the cradling member 1 in order to feel secured.

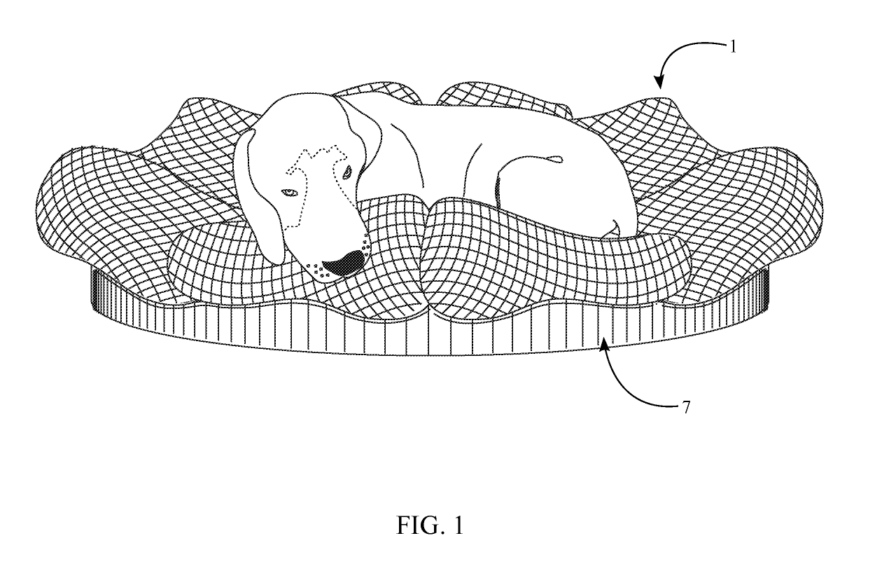

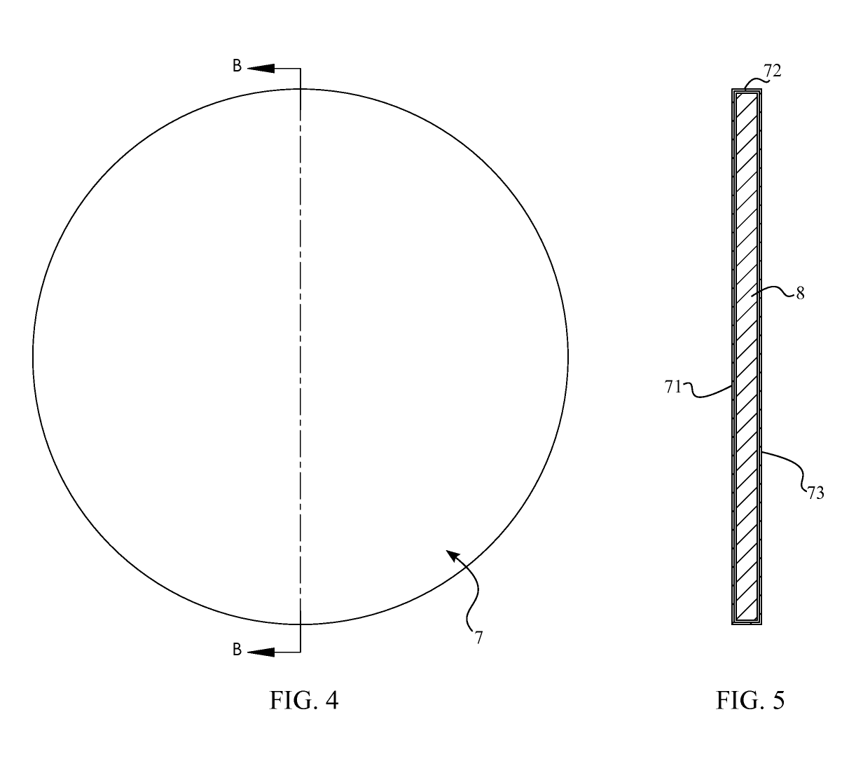

In reference to FIG. 1, FIG. 4, and FIG. 5, the first embodiment of the present invention comprises a plurality of radial members 4 as the cradling member 1, the cushion cover 7, and the cushion base 8. The cushion base 8 can potentially come in a variety of shapes. The cushion base 8 can be potentially shaped like common geometric shapes, but are not limited only to the geometric shapes and can be any other shapes. The cushion base 8 provides a soft base for the present invention where the cushion base 8 can be made from polyurethane or any other kind of light weight and flexible materials that can provide a soft surface for the weight of desired animals.

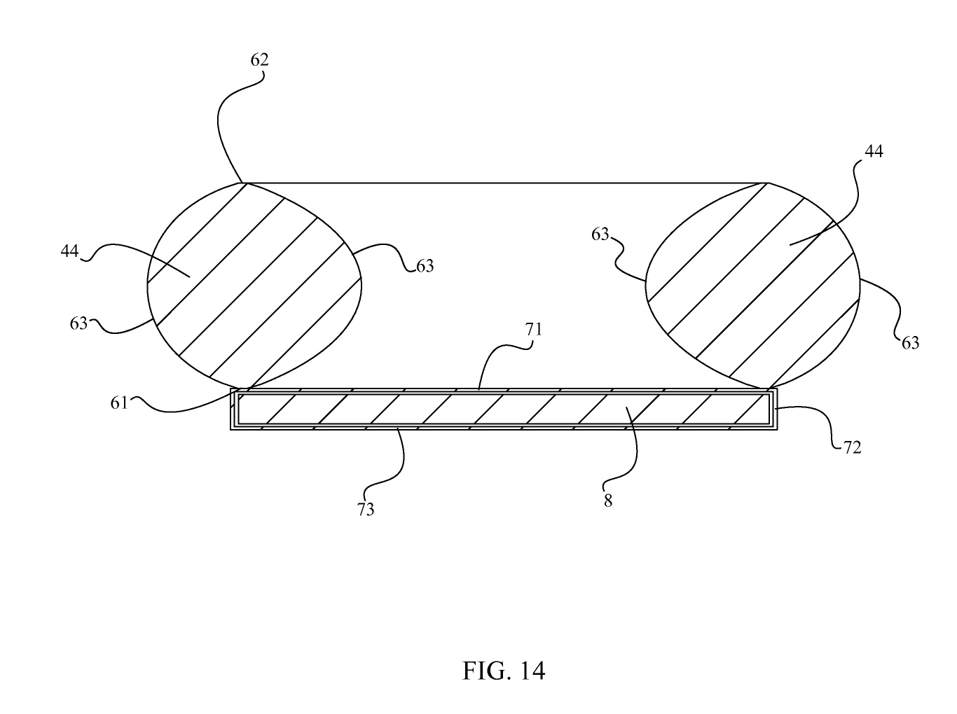

In reference to FIG. 5 and FIG. 14, the cushion cover 7 is positioned around the cushion base 8 and comprises a top layer 71, a side panel 72, and a bottom layer 73. The top layer 71 and the bottom layer 73 are oppositely positioned from each other, and the side panel 72 is perimetrically positioned around the top layer 71 and the bottom layer 73. The side panel 72 adjacently connected with the top layer 71 and the bottom layer 73 creating the cushion cover 7 where the cushion cover 7 envelops the cushion base 8. The shape of the cushion cover 7 entirely depends on the shape of the cushion base 8. The cushion cover 7 can be made from polyester, cotton, micro fiber, or any other type of durable clothing materials. The cushion cover 7 materials can have properties that are similar to, but not limited to, grass, pine needles, smooth semi rough, and various other potential iterations that are not mentioned.

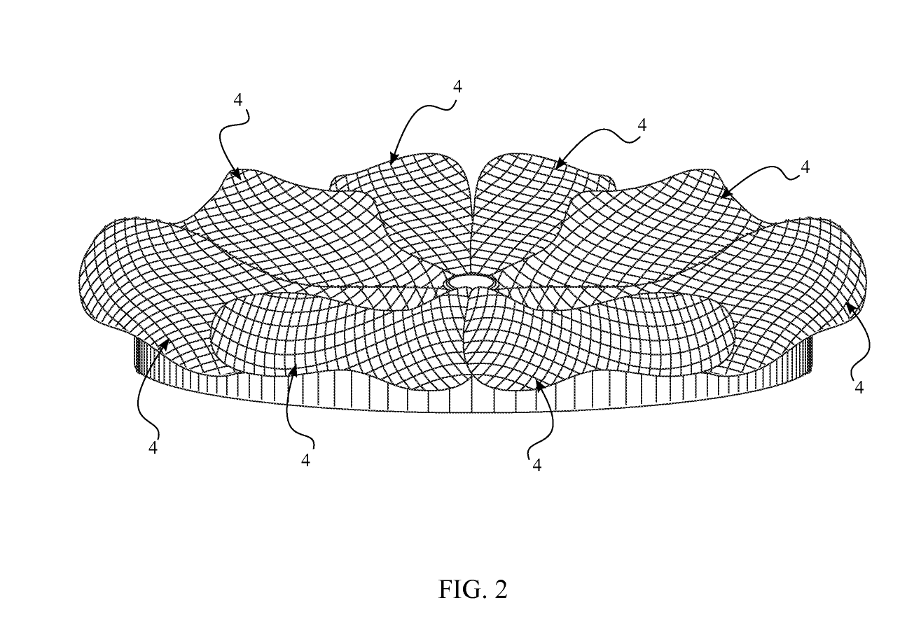

In reference to FIG. 2, the plurality of radial members 4 is positioned above the top layer 71 and the cushion base 8 with a plurality of patterns, and each of the plurality of radial members 4 comprises an inside narrow end 41, an outside wider end 42, a pillow cover 43, and filling materials 44. The plurality of radial members 4 functions as excess manageable fabric so that animals can find a comfortable resting place within the first embodiment of the present invention. The pillow cover 43 provides a closed area, where the filling materials 44 are securely positioned within. The pillow cover 43 can be made from textile base fabric or any other type of animal friendly materials. The pillow cover 43 materials can have properties that are similar to, but not limited to, grass, pine needles, smooth semi rough, and various other potential iterations that are not mentioned. The filling materials 44 can be synthetic plastic, fiber, feathers, viscoelastic foam and latex, or pumped air from an external air pump as the filling materials 44 deform pillow cover 43 of each radial member 4 to different shapes upon the weight of the animals. If air is pumped into the pillow cover 43 of each radial member 4 as the filling materials 44, each of the radial members 4 further comprises a valve so that the external air pump can be attached. The inside narrow end 41 and the outside wider end 42 are oppositely positioned on the pillow cover 43. The pillow cover 43, the inside narrow end 41, and the outside wider end 42 of each of the plurality of radial members 4 are adjacently positioned with the top layer 71 where the inside narrow ends 41 are centrally positioned on the top layer 71, and the outside wider ends 42 are radially extended toward the side panel 72.

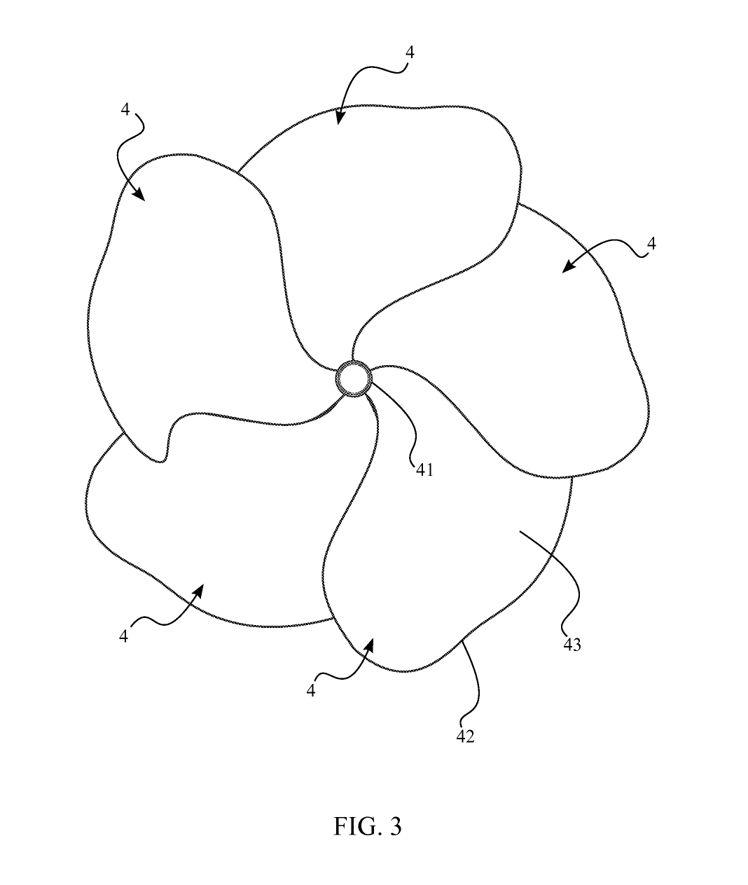

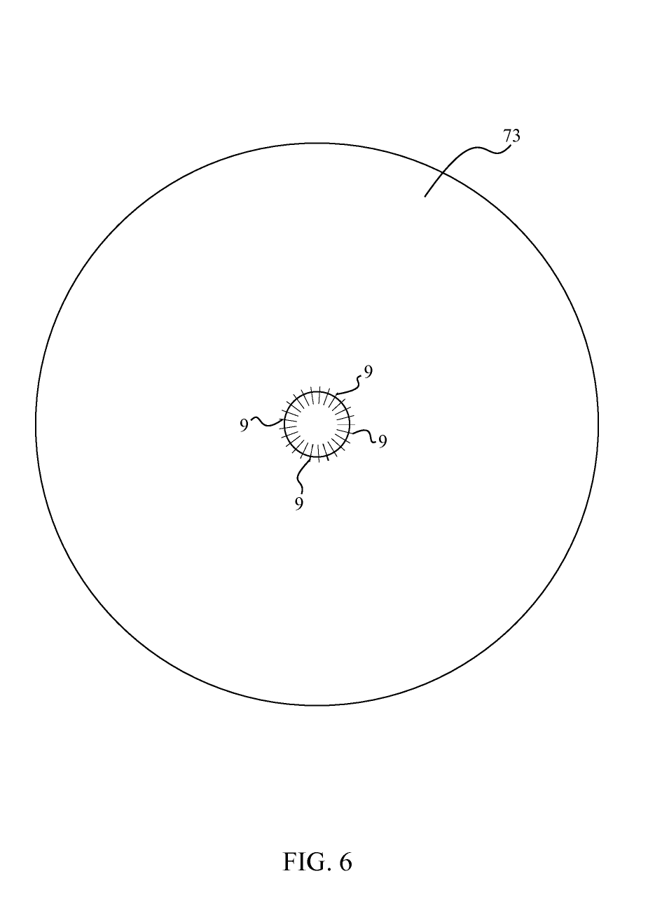

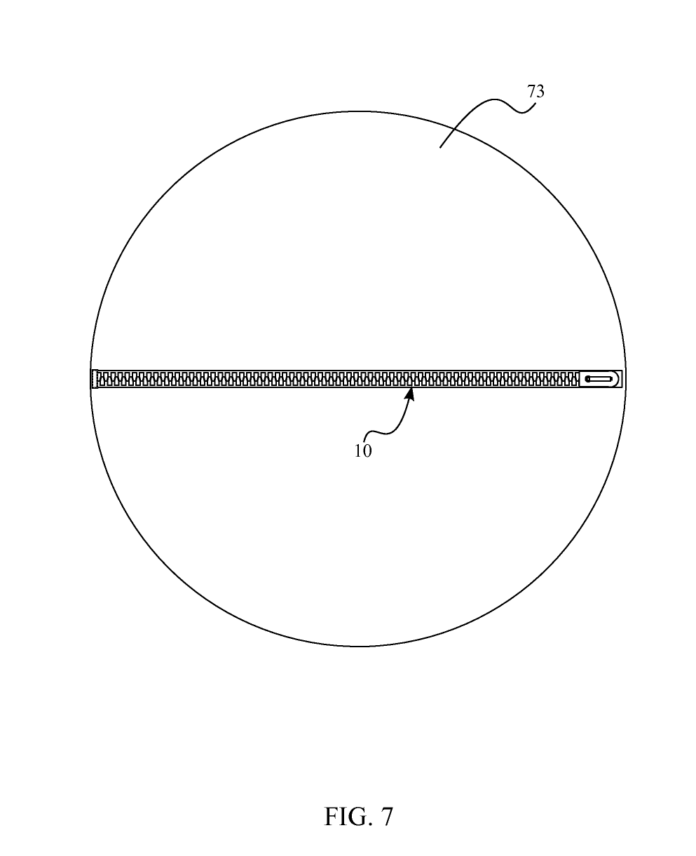

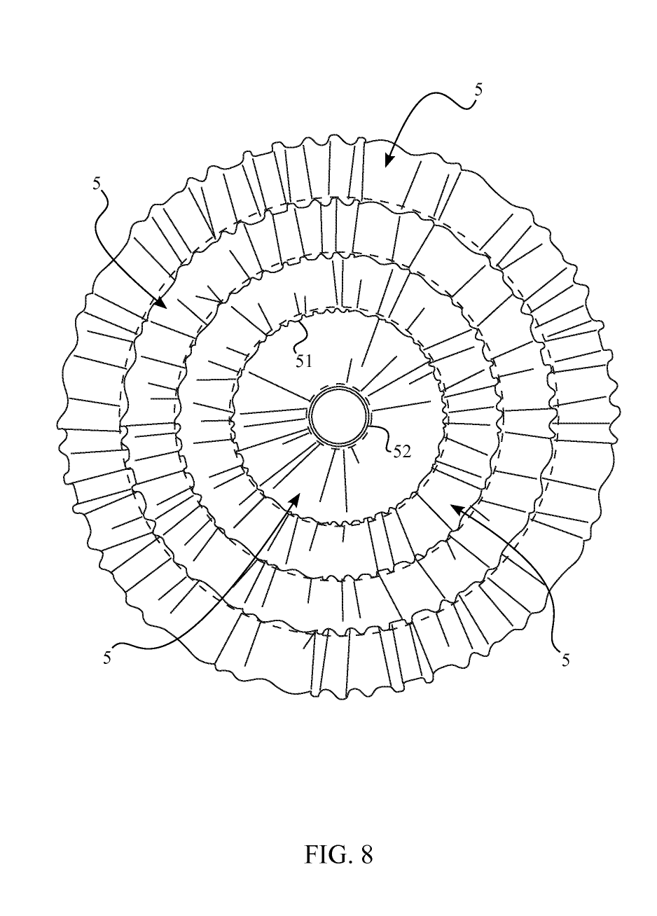

In reference to FIG. 3, the plurality of radial members 4 is individually connected to the cushion cover 7 with two different connection methods. In both methods, only the inside narrow ends 41 are connected, leaving the outside wider ends 42 free of any kind of attachments or connections. In the preferred embodiment, since the inside narrow ends 41 are much smaller than the outside wider ends 42, the inside narrow ends 41 completely connect with the cushion cover 7, but the outside wider ends 42 overlap on each other stimulating pedals of a flower pattern. The plurality of patterns in the first embodiment can include, but are not limited to spirals, grid like, radial, wave, and vector. In reference to FIG. 6, the plurality of radial members 4 can be permanently connected to the top layer 71, the cushion base 8, and the bottom layer 73 by stitches 9 or any other type connection means. When the plurality of radial members 4 is permanently connected within the first embodiment, the cushion base 8, the top layer 71, and the bottom layer 73 are simultaneously connected to the each other creating a single entity. In reference to FIG. 7, the plurality of radial members 4 can also be connected only to the top layer 71, if the bottom layer 73 further comprises an opening and closing device 10. The opening and closing device 10 can include, but is not limited to, zippers, buttons, hook and loop fastener, or other manners of opening and closing devices. Since the plurality of radial members 4 are only connected with the top layer 71, and the bottom layer 73 is equipped with the opening and closing device 10, the cushion base 8 can be easily removed from the cushion cover 7 for various reasons. For example, the plurality of radial members 4 and the cushion cover 7 can be machined washed without the cushion base 8. Additionally, once the initial cushion base 8 is worn out over time, the initial cushion base 8 can be replaced with a new cushion base 8.

In reference to FIG. 8, the second embodiment of the present invention comprises a plurality of concentric members 5 as the cradling member 1, the cushion cover 7, and the cushion base 8. The plurality of concentric members 5 is positioned above the top layer 71 and the cushion base 8 with a plurality of patterns, and each of the plurality of concentric members 5 comprises an inside edge 52 and an outside edge 51. The plurality of patterns in the second embodiment can also include, but are not limited to spirals, grid like, radial, wave, and vector. The plurality of concentric members 5 functions as excess manageable fabric so that animals can find a comfortable resting place within the second embodiment of the present invention. The concentric members 5 can be made from animal friendly materials which can have properties that are similar to, but not limited to, grass, pine needles, smooth semi rough, and various other potential iterations that are not mentioned. The outside edge 51 and the inside edge 52 are positioned around each of the plurality of concentric members 5, and the outside edge 51 has a larger parameter than the inside edge 52. The plurality of concentric members 5 adjacently positioned with the top layer 71, where the outside edge 51 is extended toward the side panel 72, and the inside edge 52 is extended toward a center of the top layer 71. Each of the plurality of concentric members 5 are positioned next to each other in such a way that the inside edge 52 of the outer concentric member 5 is adjacently positioned with the outside edge 51 of the inner concentric member 5. But the inside edge 52 of the most inner concentric member 5 is centrally positioned with the top layer 71, and the outside edge 51 of the most outer concentric member 5 is adjacently positioned with the side panel 72.

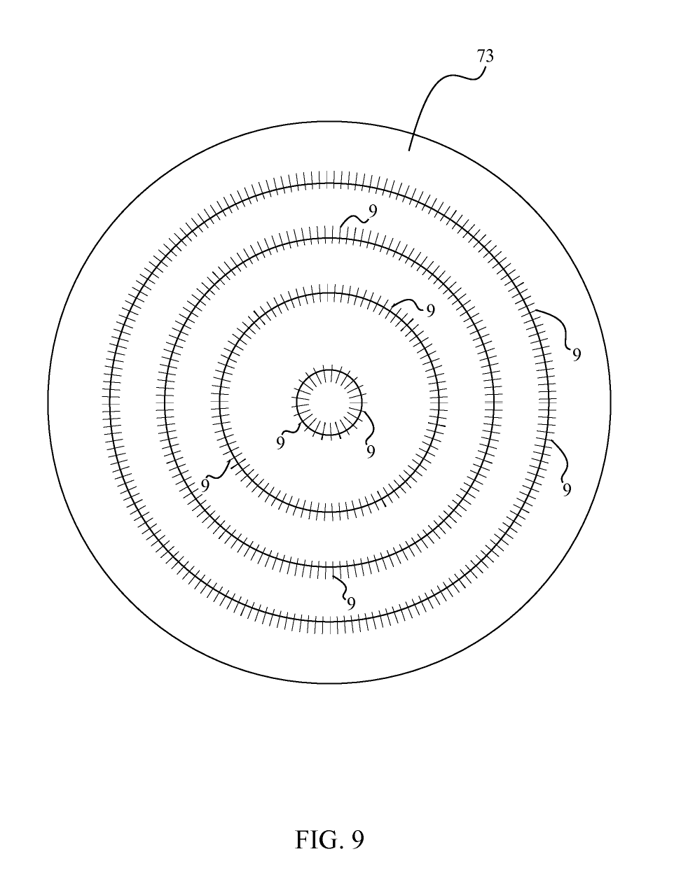

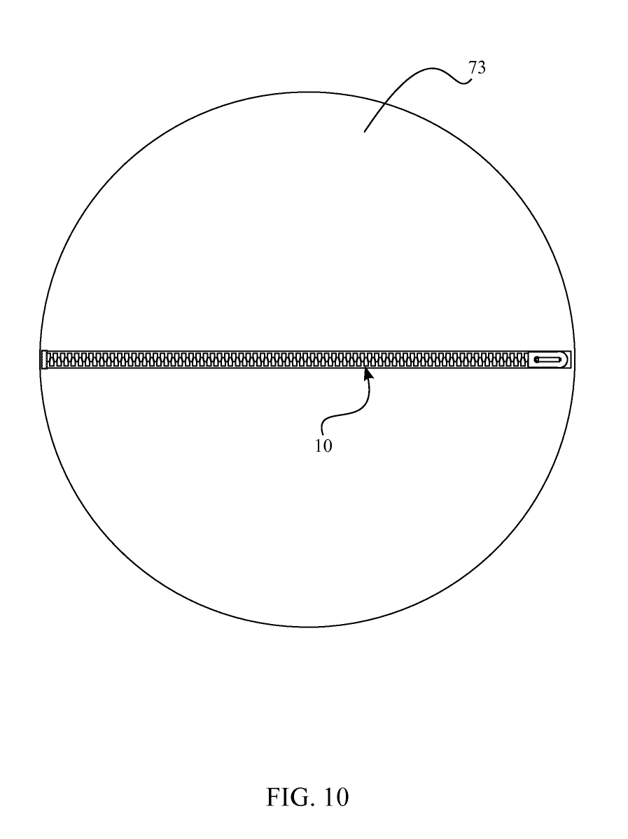

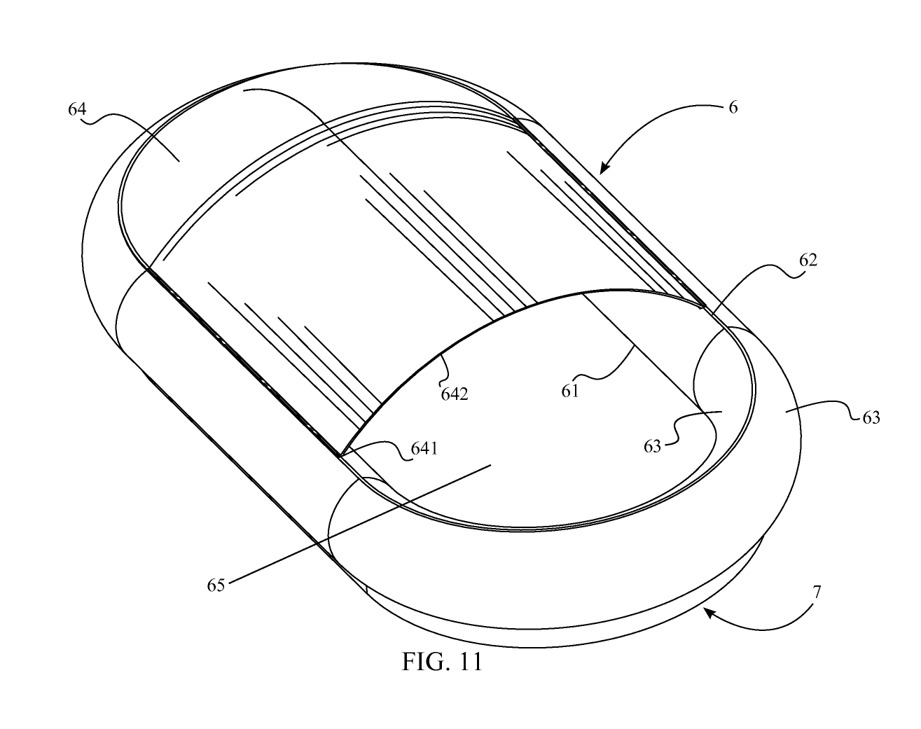

Similar to the first embodiment, the plurality of concentric members 5 in the second embodiment is individually connected to the cushion cover 7 with two different connection methods. In both methods, only the inside edges 52 are connected, leaving the outside edges 51 free of any kind of attachments or connections. In reference to FIG. 9, the plurality of concentric members 5 can be permanently connected to the top layer 71, the cushion base 8, and the bottom layer 73 by stitches 9 or any other type connection means. When the plurality of concentric members 5 is permanently connected within the second embodiment, the cushion base 8, the top layer 71, and the bottom layer 73 are simultaneously connected to the each other creating a single entity. In reference to FIG. 10, the plurality of concentric members 5 can also be connected only to the top layer 71, if the bottom layer 73 further comprises an opening and closing device 10. The opening and closing device 10 can include, but is not limited to, zippers, buttons, hook and loop fastener, or other manners of opening and closing devices. Since the plurality of concentric members 5 is only connected with the top layer 71, and the bottom layer 73 is equipped with the opening and closing device 10, the cushion base 8 can be easily removed from the cushion cover 7 through the opening and closing device 10.

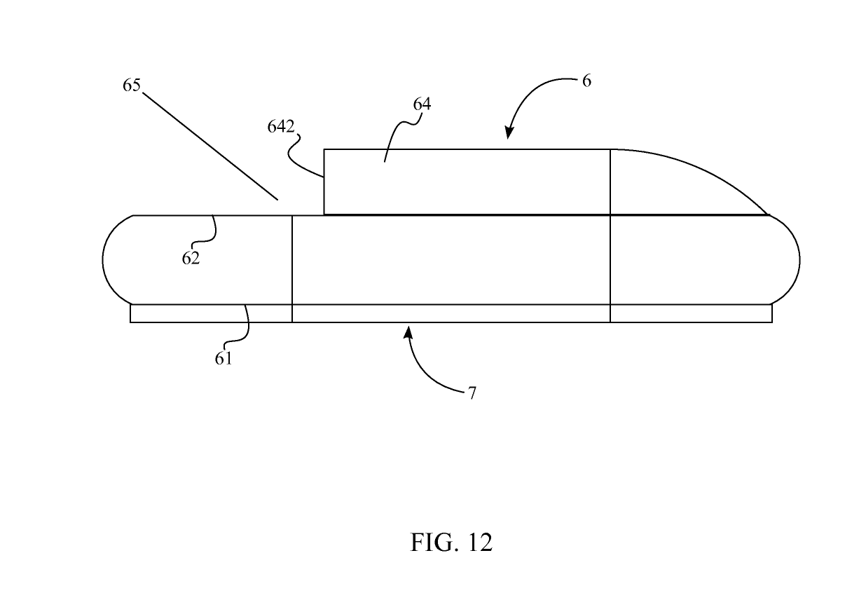

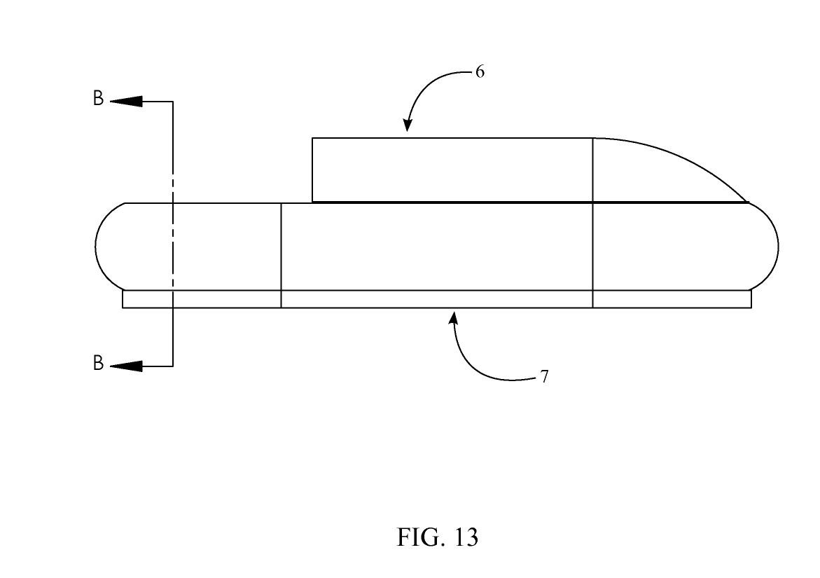

In reference to FIG. 11, FIG. 13, and FIG. 14, the third embodiment of the present invention comprises a lateral wall member 6 as the cradling member 1, the cushion cover 7, and the cushion base 8. The lateral wall member 6 is perimetrically and perpendicularly positioned with the top layer 71 and the cushion base 8 and comprises a bottom edge 61, a top edge 62, outer curvature walls 63, filling materials 44, a roof 64, and an entrance opening 65. The lateral wall member 6 functions as excess manageable materials so that the animal can find a comfortable resting place within the third embodiment of the present invention. The bottom edge 61 is adjacently and perimetrically positioned on the top layer 71, and the outer curvature walls 63 are oppositely and perimetrically connected around the bottom edge 61. The top edge 62 is positioned opposite from the bottom edge 61, where the top edge 62 is also perimetrically connected atop the outer curvature walls 63. The filling materials 44 are securely positioned within the bottom edge 61, the top edge 62, and the outer curvature walls 63. The outer curvature walls 63 can be made from textile base fabric or any other type of animal friendly materials. The outer curvature wall 63 materials can have properties that are similar to, but not limited to, grass, pine needles, smooth semi rough, and various other potential iterations that are not mentioned. The filling materials 44 can be synthetic plastic, fiber, feathers, viscoelastic foam and latex, or pumped air from an external air pump as the filling materials 44 and the lateral wall member 6 provide a barrier. Similar to the first embodiment, if air is pumped into the bottom edge 61, the top edge 62, and the outer curvature walls 63 as the filling materials 44, the outer curvature walls 63 further comprise a valve so that the external air pump can be securely attached. The roof 64 is positioned atop the top edge 62, and the roof 64 comprises a connecting edge 641 and an entrance surface 642 where the connecting edge 641 and entrance surface 642 are perpendicular to each other. When the roof 64 is connected to the lateral wall member 6, the connecting edge 641 is adjacently connected with the top edge 62, and the entrance surface 642 is perpendicularly positioned with the top edge 62. In reference to FIG. 12, the entrance opening 65, which enable the animal to enter into and exit out form the cradling member 1, is positioned in between the top edge 62 and the entrance surface 642.

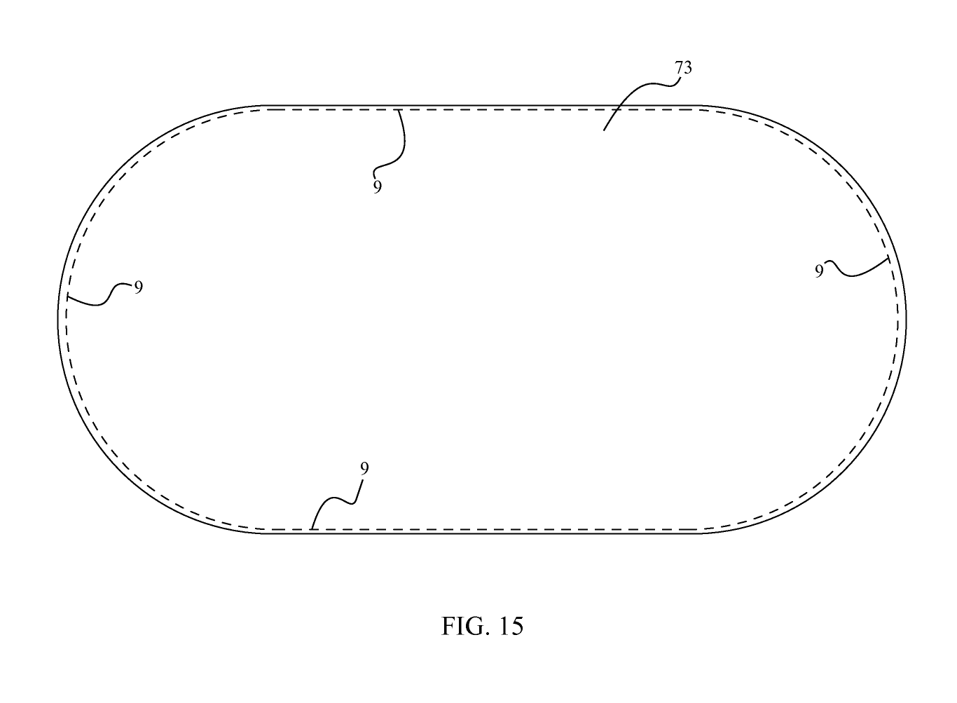

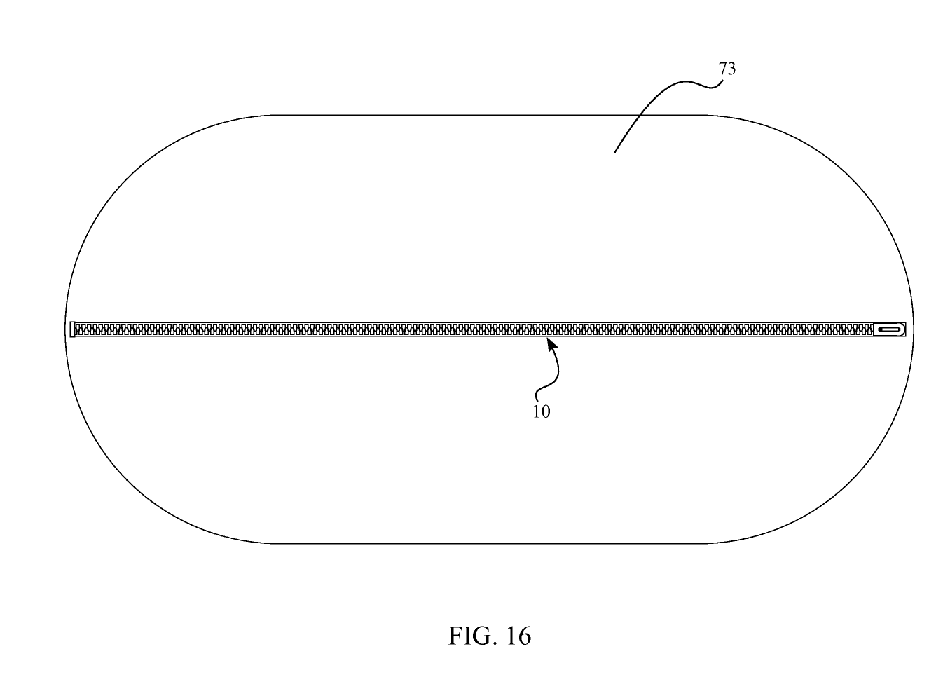

Similar to the first and second embodiments, the lateral wall member 6 in the third embodiment is connected to the cushion cover 7 with two different connection methods. In both methods, only the bottom edge 61 is connected to the cushion cover 7. In reference to FIG. 15, the lateral wall member 6 can be permanently connected to the top layer 71, the cushion base 8, and the bottom layer 73 by stitches 9 or any other type connection means. When the lateral wall member 6 is permanently connected within the third embodiment, the cushion base 8, the top layer 71, and the bottom layer 73 are simultaneously connected to the each other creating a single entity. In reference to FIG. 16, the lateral wall member 6 can also be connected only to the top layer 71, if the bottom layer 73 further comprises an opening and closing device 10. The opening and closing device 10 can include, but is not limited to, zippers, buttons, hook and loop fastener, or other manners of opening and closing devices. Since the lateral wall member 6 is only connected with the top layer 71, and the bottom layer 73 is equipped with the opening and closing device 10, the cushion base 8 can be easily removed from the cushion cover 7 through the opening and closing device 10.

The present invention can additionally have scented versions of the cradling member 1 that are well suited to simulate what an animal would sleep-on in nature. For example, the scented versions of the cradling member 1 may have pine scent, grass scent or any other type of scents. The scents can be potentially incorporated into the fabric of the cradling member 1, or a separate scent distributing mechanism that operates on a time cycle can be attached with the cradling member 1.

Optionally, the present invention can incorporate heating coils that would create a more inviting animal mattress for pets living in colder climates. The heating coils can be installed inside the top layer 71 where the heating element is powered by either alternating current or direct current, and controlled by a control interface.

Although the invention has been explained in relation to its preferred embodiment, it is to be understood that many other possible modifications and variations can be made without departing from the spirit and scope of the invention as hereinafter claimed.

What is claimed is:

1. An apparatus for an enhanced mattress with burrowing feature comprises,
a cradling member;
a cushion cover;
a cushion base;
the cradling member comprises members selected from the group consisting of a plurality of radial members, a plurality of concentric members, and a lateral wall member;
the cushion cover comprises a top layer, a side panel, and a bottom layer;
the cushion base being positioned within the cushion cover; and
the cradling member being positioned above the cushion over.

2. The apparatus for an enhanced mattress with burrowing feature claimed in claim 1 comprises,
the top layer being oppositely positioned with the bottom layer;
the side panel being perimetrically positioned around the top layer and the bottom layer;
the side panel being connected to the top layer and the bottom layer; and
the cushion base being adjacently positioned with the top layer, bottom layer, and the side panel.

3. The apparatus for an enhanced mattress with burrowing feature claimed in claim 1 comprises,
each of the plurality of radial members comprises an inside narrow end, an outside wider end, a pillow cover, and filling materials;
the pillow cover of each radial member being adjacently positioned with the top layer;
the filling materials being securely positioned within the pillow cover of each radial member;
the inside narrow end of each radial member being oppositely positioned from the outside wider end of each radial member;
the outside wider end of each radial member being radially extended toward the side panel; and
the inside narrow end of each radial member being centrally positioned on the top layer.

4. The apparatus for an enhanced mattress with burrowing feature claimed in claim 3 comprises,
the inside narrow end of each radial member being firmly connected to the top layer, wherein the bottom layer further comprises an opening and closing device so that the cushion base can be interchange.

5. The apparatus for an enhanced mattress with burrowing feature claimed in claim 3 comprises,
the inside narrow end of each radial member being simultaneously connected to the top layer, the cushion base, and the bottom layer, wherein the cushion base is permanently positioned within the cushion cover.

6. The apparatus for an enhanced mattress with burrowing feature claimed in claim 1 comprises,
each of the plurality of concentric members comprises an inside edge and an outside edge;
each of the plurality of concentric members being adjacently positioned with the top layer;
the outside edge and the inside edge being positioned around each of the plurality of concentric members;
the outside edge of each concentric member being a larger parameter than the inside edge of each concentric member;
the outside edge of each concentric member being extended toward the side panel; and
the inside edge being of each concentric member being extended toward a center of the top layer.

7. The apparatus for an enhanced mattress with burrowing feature claimed in claim 6 comprises,
the inside edge of each concentric member being firmly connected to the top layer, wherein the bottom layer further comprises an opening and closing device so that the cushion base can be interchange.

8. The apparatus for an enhanced mattress with burrowing feature claimed in claim 6 comprises,
the inside edge of each concentric member being simultaneously connected to the top layer, the cushion base, and the bottom layer, wherein the cushion base is permanently positioned within the cushion cover.

9. The apparatus for an enhanced mattress with burrowing feature claimed in claim 1 comprises,
the lateral wall member comprises a bottom edge, a top edge, an outer curvature walls, filling materials, a roof, and an entrance opening;
the lateral wall member being perimetrically and perpendicularly positioned on the cushion cover;
the bottom edge being adjacently and perimetrically positioned on the top layer;
the outer curvature walls being oppositely positioned from each other;
the outer curvature walls being perimetrically connected to the bottom edge;
the top edge being oppositely positioned from the bottom edge and perimetrically connected atop to the outer curvature walls;
the filling materials being securely positioned within the bottom edge, the outer curvature walls, and the top edge;
the roof being positioned atop the top edge; and
the entrance opening being positioned in between the top edge and the roof.

10. The apparatus for an enhanced mattress with burrowing feature claimed in claim 9 comprises, the roof comprises a connecting edge and an entrance surface;
the connecting edge and the entrance surface being perpendicularly positioned from each other;
the connecting edge being adjacently connected with the top edge;
the entrance surface being perpendicularly positioned with the top edge; and
the entrance opening being positioned in between the top edge and the entrance surface.

11. The apparatus for an enhanced mattress with burrowing feature claimed in claim 9 comprises,
the bottom edge being firmly connected to the top layer, wherein the bottom layer further comprises an opening and closing device so that the cushion base can be interchange.

12. The apparatus for an enhanced mattress with burrowing feature claimed in claim 9 comprises,
the bottom edge being simultaneously connected to the top layer, the cushion base, and the bottom layer, wherein the cushion base is permanently positioned within the cushion cover.
